(19) United States
(12) Patent Application Publication
(10) Pub. No.: US 2003/0093608 A1
(43) Pub. Date: May 15, 2003

(54) Method for increasing peripheral component interconnect (PCI) bus thoughput via a bridge for memory read transfers via dynamic variable prefetch

(76) Inventors: Ken Jaramillo, Phoenix, AZ (US); Shih Ho Wu, Mesa, AZ (US); Frank Ahern, Scottsdale, AZ (US)

Correspondence Address: Robert C. Klinger, Jackson Walker L.L.P., 2435 North Central Expressway, Suite 600, Richardson, TX, 75080, US

(21) Appl. No.: 10/039,707

(22) Filed: Nov. 9, 2001

(51) Int. Cl. G06F 13/36

(52) U.S. Cl. 710/310

(57) ABSTRACT

The invention provides a high speed PCI-to-PCI bridge structure and method of use thereof. One embodiment provides a first bus (240) adapted to facilitate data transfer, a second bus (215) adapted to facilitate data transfer, and a bridge (350) that couples the first bus to the second bus. The bridge is adapted to perform memory read, memory read line, and memory read multiple commands (from the first bus to the second bus). Advantageously, the bridge (350) responds to the memory read multiple command differently than either the memory read or the memory read line command.

### BACKGROUND

1. Technical Field of the Invention

The present invention relates to improving memory read performance of a PCI bus, and more particularly to methods of processing prefetchable Memory Read Multiple cycles via a bridge.

2. Problem Statement

A Peripheral Component Interconnect (PCI) bus supports three main types of bus cycles: Configuration, Input/Output (I/O), and Memory. Configuration and I/O cycles make up a very small percentage of PCI bus cycles. However, memory cycles constitute the vast majority of PCI bus cycles on a typical PCI bus.

Memory cycles can be broken up into 2 types: read cycles (reads), and write cycles (writes). Read cycles typically dominate bus traffic, and include memory read, memory read line, and memory read multiple commands. Typical applications have a greater percentage of read traffic in comparison to write traffic. However, read transfers suffer from the fact that they are inherently less efficient than write transfers. Accordingly, methods are needed for increasing PCI bus throughput for memory read transfers.

High performance devices tend to use the memory read multiple commands when requiring a large amount of data to achieve higher memory read performance. These commands are supported by most processor chipsets today resulting in the fetching of multiple cache lines of data when they are the target of such commands. However, when a PCI bridge is used to create a first bus and a second bus they tend to threat all memory read commands the same resulting in the pre-fetching of the same data. Conventional PCI bridge chips thus cause data transfers to take place as smaller less efficient bursts, creating a serious system performance impact.

There is a desire to provide an enhanced solution for increasing data transfers over a PCI-PCI bridge for facilitating improved transfer of data between high performance devices.

### SUMMARY OF THE INVENTION

The invention provides technical advantages as an innovative method and system for enhancing memory read performance of a PCI bus over a bridge by extending the size of the read prefetch for Memory Read Multiple cycles. One embodiment provides a first bus adapted to facilitate data transfer, a second bus adapted to facilitate data transfer, and a bridge that couples the first bus to the second bus. The bridge is adapted to perform memory read, memory read line, and memory read multiple commands (from the first bus to a target on the second bus). Advantageously, the bridge responds to the memory read multiple command differently than either the memory read or the memory read line command to achieve increased data transfer across the bridge, especially between high performance devices.

In an alternative embodiment, the invention is a controller adapted to facilitate data transfer between a first bus and a second bus. The controller in the alternative embodiment is adapted to prefetch more data from the target in response to the memory read multiple command than other memory read commands.

This invention offers an optimal solution for PCI to PCI bridge designs that matches the type of memory read operation (and the performance need that it implies) with the most appropriate read prefetch size. Memory read and memory read line operations typically imply that smaller amounts of data are being requested, and are used by most PCI based chips. Therefore, these operations should correspond to the smallest memory read prefetch sizes. Memory read multiple operations typically imply that very large amounts of data are being requested, and are used by the highest performance PCI based chips. Thus, these operations should correspond to the largest memory read prefetch sizes.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a block diagram illustrating prefetching data from a target over a PCI-PCI bridge;

FIG. 2 is a block-flow diagram of a conventional PCI to PCI bridge handling a memory read multiple command; and

FIG. 3 is a block diagram of a PCI-to-PCI bridge handling memory read multiple commands.

### DETAILED DESCRIPTION OF A PREFERRED EMBODIMENT

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a similar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a similar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

There are 3 types of memory read cycles: memory read, memory read line, and memory read multiple. Memory read cycles are the basic memory read command. They support single data phase as well as burst operation, and support data prefetching. Memory read commands have no specific relationship with Cache memory or Cache lines. They have no implied size requirements, and although they are the basic memory read command, they are typically not used in high performance situations.

Memory read line cycles are used typically when a device is accessing Cache memory (although they can be used by a device accessing non-cache memory as well). They support single data phase as well as burst operation and support data prefetching. Memory read line commands relate to cache memory and cache lines in that they are intended to access data in cache line sized chunks. For example, if the system cache line size is 16 DWords, then a memory read line command usually implies that the originating device intends to transfer a cache line worth of data (in this case 16 Dwords).

Memory read multiple cycles are used typically when a device is accessing Cache memory (although they can be used by a device accessing noncache memory as well). They support single data phase as well as burst operation, and support data prefetching. Memory read multiple commands relate to cache memory and cache lines in that they are intended to access data in cache line size chunks (similar to memory read line commands).

However, the use of memory read multiple commands implies that the requestor wants to transfer multiple cache lines (not a single cache line like the memory read line command). Because of this, the memory read multiple command has an implied data prefetch of multiple cache lines. This offers much higher read performance for high end systems. Accordingly, systems which aim at high memory read performance tend to use memory read multiple commands. Typical systems are high speed disk arrays (for example, SCSI hard disk) and graphics chips.

The invention provides optimal PCI to PCI bridge designs that match the type of memory read operation (and the performance need that it implies) with the most appropriate read prefetch size. Memory read and memory read line operations typically imply smaller amounts of data being transferred and are used by most PCI based chips. Therefore, these operations correspond to the smallest memory read prefetch sizes. Memory read multiple operations typically imply very large amounts of data being transferred, and are used only by the highest performance PCI based chips. Therefore these operations correspond to the largest memory read prefetch sizes.

Prefetching is a concept used with memory read commands to boost memory read performance. In one simple implementation, a device (target device), such as a PCI to PCI bridge, is the target of a memory read command (memory read, memory read line, or memory read multiple). The device reads (also called “fetches”) a fixed amount of data (for example, 8 DWords, or 16 DWords) even though the target device doesn't know at the start of the PCI bus cycle how much data is desired by the requesting device. What the target device (the PCI to PCI bridge in this exemplary case) hopes is that it fetches more data than the requesting device needs. The target device “pre”-fetches data before it actually sees that the requesting device actually wants it. Thus, by the time the requesting device actually gets to the point of requesting the data, the data is hopefully already fetched by the target. Thus, prefetching is more optimal than fetching a data value only when the target device sees that the requesting device wants it.

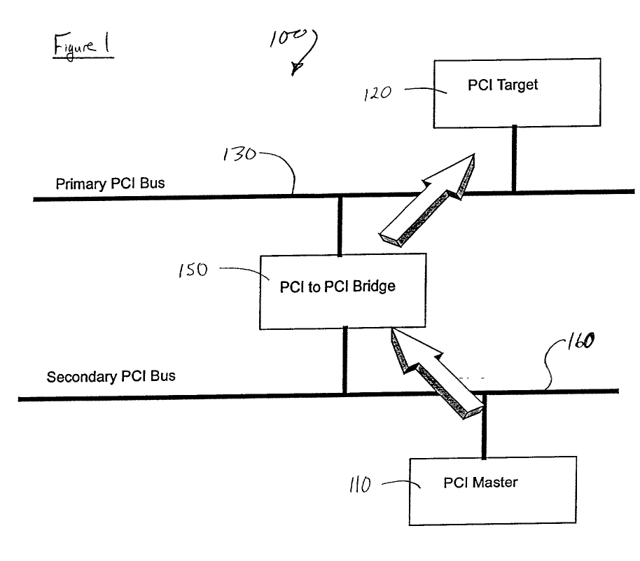

FIG. 1 shows a system and method of prefetching at 100. A PCI Master 110 desires to read an undetermined amount of data from a PCI Target 120. The PCI Master 110 in this case could be a USB device, a hard disk controller, or any PCI Master type device, for example. The PCI Master 110 starts a PCI memory read cycle for an undetermined amount of data. A PCI to PCI bridge 150 passes a memory read command up to primary PCI bus but requests several DWords of data in anticipation that the PCI Master 110 will want them as well.

The PCI Target 120 represents any PCI based memory resource sitting on a primary PCI bus 130. The PCI Master 110 starts off by initiating a PCI Memory read cycle that specifies the PCI Target address. The PCI to PCI bridge 150 typically accepts the PCI cycle but tells the PCI Master 110 to retry the cyclelt does this because the read command may take varying amounts of time to complete and it's more efficient to have the PCI Master 110 release a secondary PCI bus 160 so that others may use it.

The PCI to PCI bridge 150 then passes this transfer up to the primary PCI bus 130 to access the PCI Target 120 for the PCI Master 110. The problem is that the PCI bus protocol does not allow the PCI to PCI bridge device to know how much data the PCI Master 110 had intended to transfer. In an attempt to be efficient, the PCI to PCI bridge 150 requests several DWords of data from the PCI Target 120. The size of the “prefetch” is chosen to be optimal. If the prefetch is too small, then the bridge won't fetch enough data and the PCI Master 110 will have to make another request for the rest of the data. If the “prefetch” is chosen too large then time is wasted fetching data that is not needed.

The fact that the data is prefetched for the PCI Master 110 makes the overall transfer more efficient. For example, the initial memory read from the PCI Target 120 might have taken two microseconds to complete. The subsequent data cycles would probably complete very quickly afterwards as a part of the burst cycle (for example, once every thirty nanoseconds). Without the prefetch, the two microsecond access time would be incurred for each data phase, for a total access time of 64*2 microseconds=128 microseconds.

How Typical PCI to PCI Bridge Devices Handle Memory Reads, Prefetching

High performance devices, such as PCI Based SCSI disk controllers and graphics chipsets, tend to use the memory read multiple commands to achieve higher memory read performance. Most processor chipsets today support the use of the memory read multiple command and fetch multiple cache lines when they are the target of such commands. One problem with this is that conventional PCI to PCI bridge chips (bridge chips) treat the memory read multiple command like any other memory read command.

Accordingly, conventional bridge chips prefetch the same amount of data with a memory read multiple command as they do with a memory read command. So bridge chips ignore the fact that a high performance device requesting data uses the memory read multiple command to attempt to read system data (typically from system RAM) in large chunks, and that the processor chipset fetches data in large chunks if correctly requested to do so. But, the intervening PCI to PCI bridges of today mess this up and cause the data transfers to take place as smaller less efficient bursts. This has a serious system performance impact.

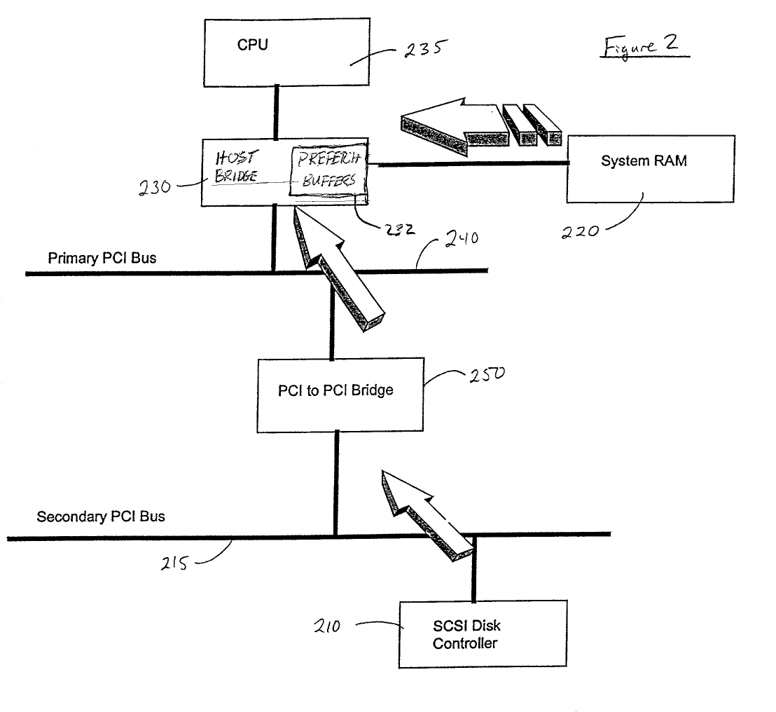

FIG. 2 provides a diagram of a PCI to PCI bridge 250 handling a memory read multiple command according to conventional techniques. Conventionally, a SCSI disk controller (disk controller) 210, that is coupled to a PCI to PCI bridge 250 via a secondary PCI bus 215, attempts to read large amounts of data from system memory 220, such as random access memory (RAM). The disk controller 210 uses the memory read multiple command in an attempt to read data from system RAM 220 in large bursts. A host bridge 230 handles memory read multiple commands (typically generated by a CPU 235) efficiently and will prefetch multiple cache lines when it receives a memory read multiple command. The initial delay (from the time the host bridge 230 receives the memory read multiple command until it starts pumping out read data) might be on the order of one or two microseconds. The subsequent data comes out quickly (each tick of the PCI clock). Thus, the host bridge 230 fetches multiple cache lines from system RAM 220 whenever it receives a memory read multiple command. After a memory read multiple command has completed, it will flush its prefetch buffers 232.

The PCI to PCI bridge (the bridge) 250, disadvantageously, conventionally passes the memory read multiple command up to the host bridge 230 as a smaller cycle than it should for optimal performance. The host bridge 230 should pass the memory read multiple command up as multiple cache lines, but instead, the host bridge 230 passes the memory read multiple command up just like any other memory read command (which is typically smaller than a cache line). Therefore, the host bridge 230 disadvantageously waits until the host bridge 230 starts to see read data come in (a one to two microsecond delay).

In other words, typical PCI to PCI bridges pass the memory read multiple command up to the host bridge, but treat it like any other memory read command. Hence, the prefetch size is usually not a multiple of cache lines, but is actually smaller than a cache line. This means the memory read operation will get broken up into lots of smaller memory reads (which is not very efficient and wastes processing time).

When the host bridge 230 stops the PCI cycle, the host bridge 230 flushes its prefetch buffers 232. The PCI to PCI bridge 250 then passes the read data down to the SCSI disk controller 210. When the host bridge 230 sees that the SCSI disk controller 210 actually wanted more data than the host bridge 230 had fetched, the host bridge 230 issues another memory read multiple command on the a primary PCI bus 240 to continue fetching data. The problem is that the one to two microsecond initial delay occurs all over again.

For example, if a cache line is 32 DWords, the PCI to PCI bridge 250 prefetch size is 8 DWords, and the SCSI disk controller 210 is attempting 64 DWord bursts. The host bridge 230 will support these 64 DWord bursts, but the conventional PCI to PCI bridge 250 will not. The PCI to PCI bridge 250 breaks up each 64 DWord burst into eight, eight DWord bursts. So, while the overall transfer could be completed in around one to two microseconds, the bridge 250, instead, completes the overall transfer in 8 to 16 microseconds because of the PCI to PCI bridge behavior. This is a serious system performance impact.

How Typical PCI to PCI Bridges Attempt to Increase Read Performance

Most conventional PCI to PCI bridges 250 do not have many built in performance enhancing features, with regard to memory read multiple commands. With typical PCI to PCI bridge devices, the applicant traditionally increased read performance by increasing the depth of the PCI to PCI bridge's internal FIFOs and increasing the memory read prefetch size uniformly for memory read, memory read line, and memory read multiple commands.

This solution is the typical approach, primarily because it is easy to implement, but this solution has a serious negative impact to overall system throughput. By increasing the size of the read prefetch, the instantaneous memory read throughput increases. However, the fact that the prefetch size increases for all types of memory read operations (rather than matching the type of read operation to the performance needs) has negative ramifications. Memory read and memory read line operations are typically used for smaller data transfers. So, with these cycles, the PCI to PCI bridge 250 will end up prefetching large amounts of read data that is never used by the requesting PCI Master.

The wasted read data results in wasted time spent by the PCI to PCI bridge 250 on the destination bus (primary PCI bus in the previous examples). This means that while the PCI to PCI bridge 250 is reading this “soon to be unused” data from the primary PCI bus, that bus cannot be used by another device that needs it. So, even though the effective memory read throughput is boosted, the deleterious affect on the overall system throughput results.

Better Solution: Dynamic Performance Enhancing Variable Prefetch

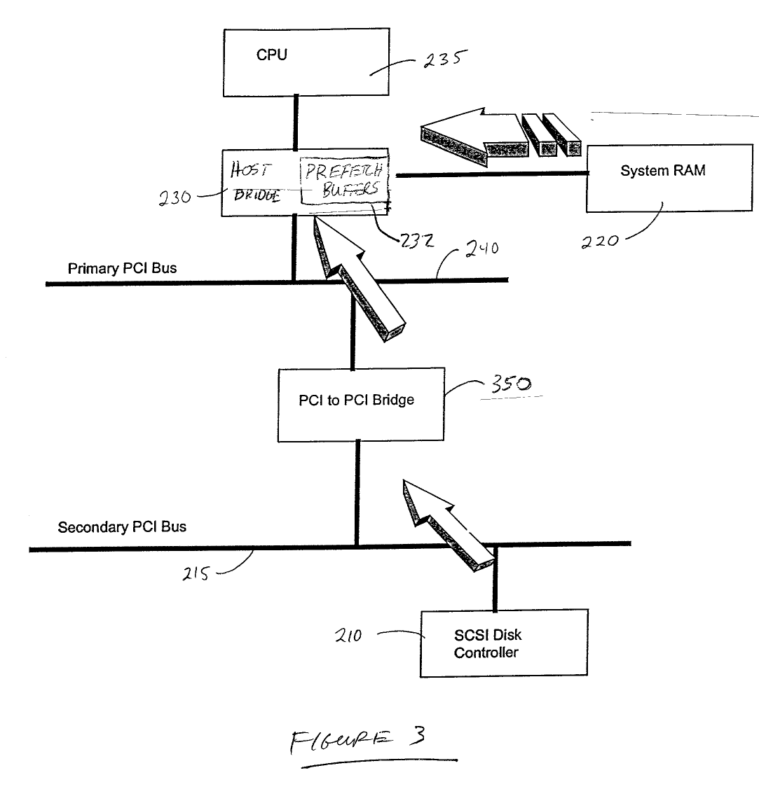

The bridge 350 according to the present invention, depicted in FIG. 3, provides programmable prefetch sizes for memory read and memory read line commands (for example, 8 DWords, or 16 DWords), and an extended prefetch size for memory read multiple commands. The improved PCI-to-PCI bridge 350 increases the memory read multiple prefetch size to four times the size of a memory read and a memory read line prefetch size. For example, if the prefetch size for memory read and memory read line commands is set to 16 DWords, then the prefetch size for memory read multiple commands is set to 64 DWords.

According to the present invention, the PCI Master design advantageously decides dynamically (or, “on the fly”) which prefetch size to use based on the PCI cycle type. The use of this feature greatly enhances the memory read performance of the PCI to PCI bridge 350 making it faster than most other PCI to PCI bridge devices 250 on the market. It raises the overall system performance dramatically. Note that the solution sets the prefetch size of memory read multiple cycles to four times the size of the other types of memory read commands. This approach can be implemented by using other multiples or with a programmable multiple, or the standard PCI specification cache line size register can be adjusted such that the PCI to PCI bridge 350 actually prefetches multiple cache lines.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A bridge apparatus, comprising:
a first bus adapted to facilitate data transfer;
a second bus adapted to facilitate data transfer; and
a bridge coupling the first bus to the second bus, the bridge adapted to perform memory read, memory read line, and memory read multiple commands from the first bus to the second bus, wherein the bridge responds to the memory read multiple command differently than either the memory read or the memory read line command.

2. The bridge apparatus of claim 1 wherein the memory read multiple command prefetches more data than the memory read command.

3. The bridge apparatus of claim 1 wherein the amount of data prefetched by the memory read multiple command is selectively variable in size.

4. The bridge apparatus of claim 1 wherein the memory read multiple command prefetches more data than the memory read line command.

5. The bridge apparatus of claim 1 wherein second bus has cache memory, wherein the bridge apparatus is adapted to perform memory read multiple command with the cache memory.

6. The bridge apparatus of claim 1 wherein second bus has RAM memory, wherein the bridge apparatus is adapted to perform memory read multiple command with the RAM memory.

7. The bridge apparatus of claim 1 wherein the bridge has a prefetch buffer, wherein the prefetch buffer is adapted to be flushed after a memory read multiple command by the first bus.

8. The bridge apparatus of claim 1 wherein the memory read multiple command utilizes at least 32 Dwords.

9. The bridge apparatus of claim 1 wherein the memory read multiple command utilizes at least 64 Dwords.

10. The bridge apparatus of claim 1 wherein a prefetch size of a memory read multiple command is at least four times as large as the size of a memory read or memory read line command.

11. The bridge apparatus of claim 1 wherein the first bus is a PCI bus.

12. The bridge apparatus of claim 1 wherein the second bus is a PCI bus.

13. The bridge apparatus of claim 1 wherein the second bus is adapted to support a SCSI disk controller.

14. The bridge apparatus of claim 1 wherein the second bus is a PCI bus.

15. A controller apparatus, comprising:
a first bus adapted to facilitate data transfer;
a second bus adapted to facilitate data transfer; and
a controller coupling the first bus to the second bus, the controller adapted to perform memory read, memory read line, and memory read multiple commands from the first bus to the second bus.

16. A method of operating a bridge coupled between a first bus and a second bus, comprising:
initiating a read multiple command on the first bus;
the bridge passing the read multiple command to a target on the second bus, wherein the bridge also supports a memory read and a memory read line command; and
the bridge treating the read multiple command differently than the memory read line command.

17. The method of claim 16 wherein the bridge prefetches more data in response to the memory read multiple command than that prefetched in response to a memory read command.

19. A controller adapted to prefetch data via a first bus from a target on a second bus, comprising a circuit adapted to respond to a memory read multiple command and a memory read line command, whereby the circuit prefetches more data from the target in response to the memory read multiple command than the memory read command.

20. The controller as specified in claim 19 wherein the circuit prefetches more data from the target in response to the memory read multiple command than the memory read line command.
